(19) United States
(12) Patent Application Publication
(10) Pub. No.: US 2026/0140785 A1
(43) Pub. Date: May 21, 2026

(54) DYNAMIC COMPUTATIONAL RESOURCE POOL SIZING FOR CLOUD PLATFORMS

(71) Applicant: NVIDIA Corporation, Santa Clara, CA (US)

(72) Inventors: Alan Daniel Larson, Cambridge, MA (US); Yury Taradzei, Sunnyvale, CA (US); Eric Eugene Knutsen, San Martin, CA (US)

(21) Appl. No.: 18/953,689

(22) Filed: Nov. 20, 2024

(51) Int. Cl. G06F 9/50

(52) U.S. Cl. CPC G06F 9/5072; G06F 9/5077

(57) ABSTRACT

A first computational resource pool of a plurality of computational resource pools of one or more data centers is identified. An estimate of maximum concurrent sessions of the first computational resource pool during a first time period is determined using an output of a first artificial intelligence (AI) model and an output of a second AI model. The output of the first AI model indicates a request rate distribution for the first computational resource pool, and the output of the second AI model indicates a session duration distribution for the first computational resource pool. A number of computational resources to allocate to the first computational resource pool for the first time period is determined using the estimate of maximum concurrent sessions.

### TECHNICAL FIELD

Aspects and embodiments of the present disclosure relate to computational resources in cloud platforms, and in particular to dynamic computational resource pool sizing for cloud platforms.

### BACKGROUND

Cloud platforms can include one or more data centers each having multiple hosts. A host can be a server having one or more hardware resources such as graphics processing units (GPUs), network interface controllers (NICs), data processing units (DPUs), or similar. In some cases, a hardware resource (e.g., a GPU) can be split into multiple virtual resources (e.g., vGPUs), each having lower power/resources than a full hardware resource. An instance such as a virtual machine can run on one of the hosts with one or more hardware resources or virtualized resources assigned to it. Per user request, an instance can be used to perform computational tasks.

### BRIEF DESCRIPTION OF DRAWINGS

Various embodiments in accordance with the present disclosure will be described with reference to the drawings, in which:

FIG. 1A is a block diagram of an example system architecture for providing dynamic computational resource pool sizing for cloud platforms, in accordance with an embodiment;

FIG. 1B is a block diagram of an example data center, in accordance with an embodiment;

FIG. 2 is a block diagram of example computational resources, in accordance with an embodiment;

FIG. 3 is a block diagram of example resource pool data structures corresponding to example resource pools, in accordance with an embodiment;

FIGS. 4A-4C are a flow diagram of an example method for providing dynamic computational resource pool sizing for cloud platforms, in accordance with an embodiment;

FIG. 5 is a block diagram of an example computing device, in accordance with an embodiment;

FIG. 6 illustrates an example data center, in accordance with an embodiment;

FIG. 7 is an example system diagram for a content streaming system, in accordance with an embodiment; and

FIGS. 8A-8B illustrate inference and/or training logic used to perform inferencing and/or training operations, in accordance with an embodiment.

### DETAILED DESCRIPTION

Aspects of the present disclosure relate to dynamic resource pool sizing for cloud game-streaming platforms and other types of cloud platforms. Cloud platforms can include one or more data centers each having multiple hosts. A host can be a server having one or more hardware resources such as graphics processing units (GPUs), network interface controllers (NICs), data processing units (DPUs), or similar. In some cases, a hardware resource (e.g., a GPU) can be split into multiple virtual resources (e.g., vGPUs), each having lower power/resources than a full hardware resource. An instance such as a virtual machine can run on one of the hosts with one or more hardware resources or virtualized resources assigned to it. Users (e.g., gamers) can request to stream a video game or to perform other computational tasks. In response, a session with an instance can be initiated. The instance resources (e.g. GPU power) to be used during the session can be related to the user's session priority, which can correspond to a paid subscriber tier, a free tier, an ad-supported tier, or similar. A user's session priority can further determine whether or for how long the user has to wait in a queue before an instance becomes available. Hosts/instances can be grouped into pools corresponding to session priorities. For example, a set of hosts in a data center can be allocated to a highest priority session pool, which has higher-power GPUs and sufficient hosts to minimize queueing. The remaining hosts can be allocated to a lower priority session pool(s) having lower-power GPUs and potentially more queueing.

The above-described systems can face several challenges relating to setting pool sizes (e.g., the number and type of hosts/instances per pool) to minimize idle resources and queueing. Some systems can be managed by site reliability engineers (SREs) who manually set pool sizes. SREs often allocate large numbers of hosts to pools for high-priority sessions to minimize queueing for users of these pools. However, usage trends can vary over periods of time (e.g., hours, days, weeks), which can lead to idle resources in pools for high-priority sessions. For example, SREs can allocate sufficient hosts to a pool for high-priority sessions to meet heightened demand on nights and weekends, but the same pool may have many idle hosts during low-demand periods such as during the workday. While these hosts are idle, users in lower-priority sessions with fewer hosts allocated to the associate pools can experience unnecessary queueing. Furthermore, even conservative allocation of hosts to high-priority session pools can result in excessive queueing for users of those pools in exceedingly high demand scenarios, such as after releases of new games or during scheduled gaming events. These challenges can be exacerbated by the large number of pools that SREs can manage (e.g., hundreds of pools), which can be difficult to manually optimize. As a result of these challenges, cloud platforms can experience underutilization of idle resources and users of these platforms can have negative user experiences related to queueing.

Aspects of the present disclosure address the above challenges and other challenges with a system and process for automatically adjusting pool sizes at regular intervals based on historical pool occupancy data. An example process can include one or more of the following operations: (i) obtaining historical usage data for each pool, (ii) fitting one or more statistical models to the historical usage data, (iii) simulating worst-case maximum occupancy in each pool for an upcoming time period, and (iv) balancing resource allocation to each pool based on simulations and session priorities.

An example system can obtain historical usage data for each pool type, which can correspond to specific combinations of host/instance type, session priority, and/or other factors. The historical usage data can include request time data and session duration data. The request time data can correspond to each occurrence (e.g., at a specific time) of a user requesting to use pool resources for a session (e.g., gaming session). The session duration data can correspond to the length (e.g., in minutes) of each user session. The historical usage data may be obtained based on a target time period for which the system can adjust pool sizes. For example, if the system is adjusting pool sizes for a 1-hour time period on an upcoming Saturday at 4 pm, the system can obtain request time and session duration data for past Saturdays at 4 pm-5 pm (e.g., for the past four Saturdays).

An example system can train one or more statistical models on historical usage data for one or more resource pools. For example, the system can train/update two models for each pool type: a model to fit the distribution of request time data, and a model to fit the distribution of session duration data. The request time data model can correspond to, for example, a Poisson distribution. The session duration data model can correspond to, for example, a Weibull distribution.

An example system can simulate maximum occupancy for one or more resource pools using statistical models. For example, the system can use statistical models for request times (e.g., a Poisson distribution) and session durations (e.g., a Weibull distribution) to generate simulated session requests and session durations for a target time period. The system can determine the maximum number of concurrent active sessions by adding overlapping sessions based on the simulated requests and durations. This simulation can be performed multiple times (e.g., tens, hundreds, thousands of times) to determine a worst-case maximum number of concurrent active sessions for each resource pool, and thus the maximum number of resources to allocate to each pool to minimize queueing.

An example system can balance resource allocation to one or more resource pools based on simulated maximum concurrent active sessions and further based on session priorities for different pools. For example, a high-priority pool can be allocated sufficient resources to support the simulated worst-case maximum concurrent active sessions for a target time period to minimize queueing. The remaining computational resources can be divided among the other lower-priority pools.

Accordingly, aspects of the present disclosure result in improved utilization of available cloud resources, as well as reduced queueing for users and improved user experience.

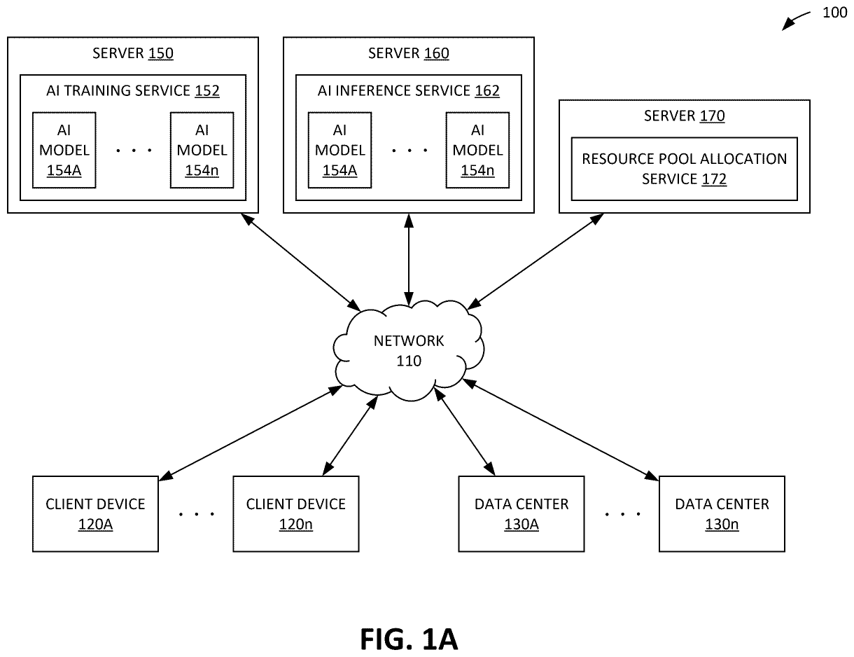

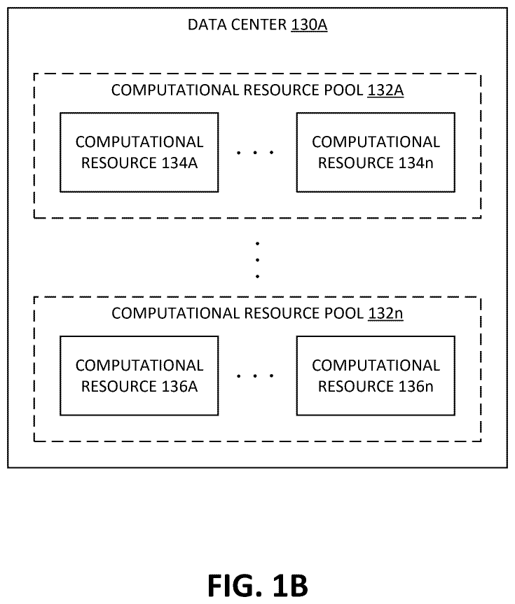

FIG. 1A is a block diagram of an example system architecture 100 for providing dynamic computational resource pool sizing for cloud platforms, in accordance with an embodiment. System architecture 100 (also referred to as “system” herein) includes network 110, client devices 120A-120n, data centers 130A-130n, and servers 150-170. In various embodiments, system 100 can include more or fewer components in different configurations than those depicted in FIG. 1A. For example, system 100 can include additional servers, networks, etc. In another example, servers 150-170 can be combined.

Network 110 can include a public network (e.g., the Internet), a private network (e.g., a LAN, a WAN, a VPN, an enterprise network), a wired network (e.g., Ethernet), a wireless network (e.g., an 802.11 Wi-Fi network), a cellular network (e.g., a 5G network), routers, hubs, switches, server computers, or a combination thereof. Network 110 or components thereof can be associated with different organizations in various embodiments. For example, components of network 110 can be associated with Internet Service Providers (ISPs), mobile or cellular carriers, cloud platform or software-as-a-service (SaaS) providers, private or public enterprises, private households or communities, etc. In an embodiment, network 110 (or a component thereof) can be a physical or virtual interconnect within a single device, such as a PCIe bus, a messaging system, or an API.

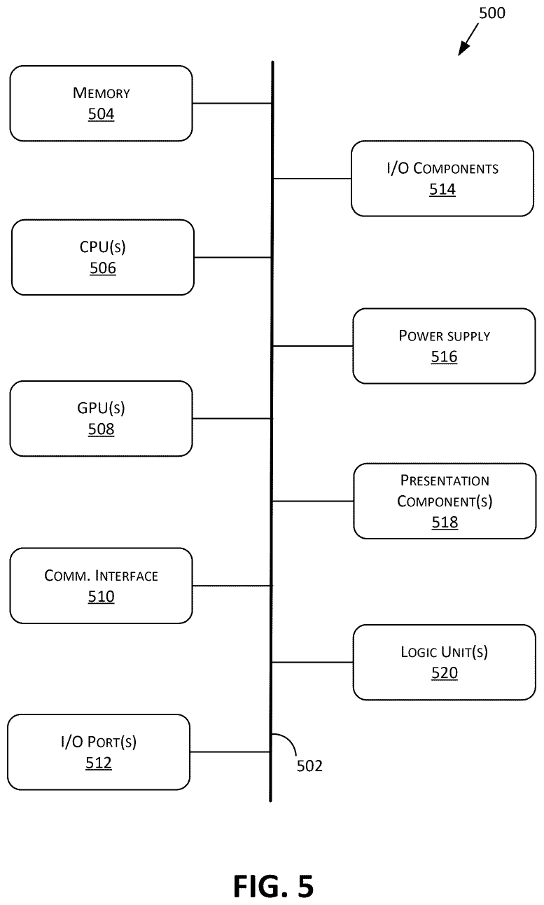

Client devices 120A-120n can be personal computers (PCs), laptops, notebook computers, mobile phones, smartphones, tablet computers, digital assistants, network-connected televisions (e.g., smart TVs), handheld gaming devices, gaming consoles, or any other computing devices. The computer system of FIG. 5 can be an example of a client device. In various embodiments, client devices 120A-120n can also be referred to as “user devices.” Client devices 120A-120n can run an operating system (OS) that manages hardware and software of the client devices. Client devices 120A-120n can further include a web browser, application, or other software for interacting with servers 150-170 and/or computational resources of data centers 130A-130n. Client devices 120A-120n can be used by users such as gamers, data scientists, graphic artists, or similar users benefiting from cloud-based computational resources. In general, and as described herein, functions described in embodiments as being performed by server devices 150-170 can also or alternatively be performed on client devices 120A-120n in other embodiments. In addition, the functionality attributed to a particular component can be performed by different or multiple components operating together.

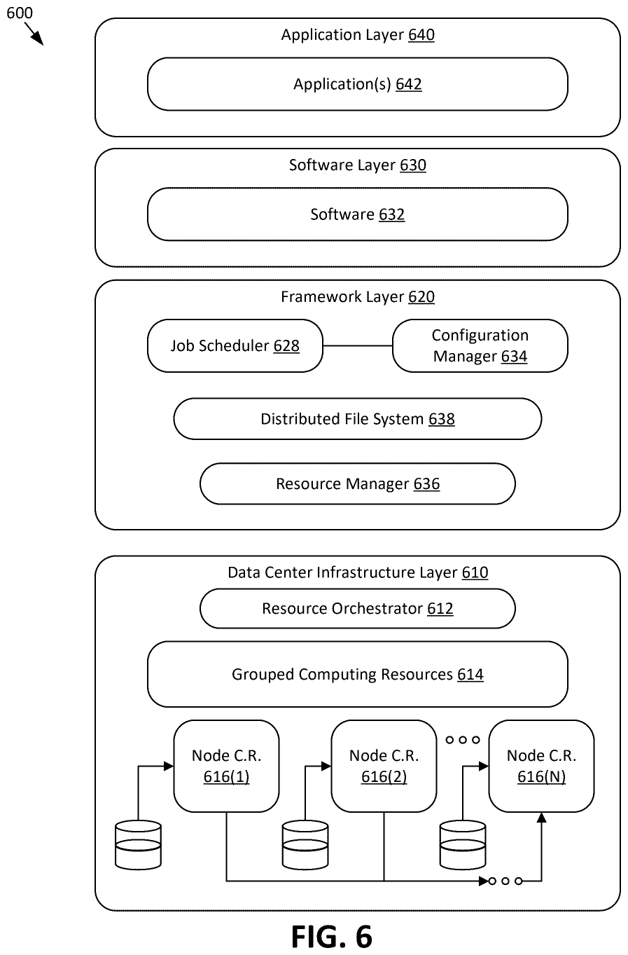

Each of data centers 130A-130n can include computational resources used by client devices 120A-120n. Example data center 130A is further described with reference to FIG. 1B. Further examples of data centers and associated components are described with reference to FIG. 6.

Each of servers 150-170 can be a rackmount server, a router computer, a personal computer, a portable digital assistant, a mobile phone, a laptop computer, a tablet computer, a netbook, a desktop computer, a virtual machine (VM), a container, etc., or any combination of the above. The computer system of FIG. 6 can be an example of a server. In various embodiments, each of servers 150-170 can be several computing devices, such as multiple rackmount servers in a data center(s) or multiple VMs in a cloud platform. In an embodiment, functions provided by servers 150-170 can alternatively be provided by a single server.

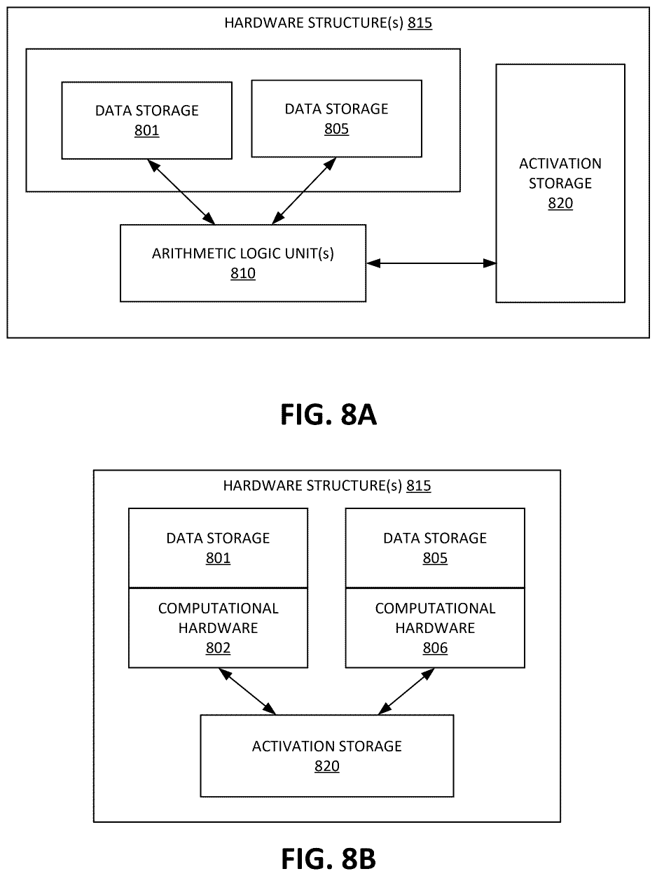

Server 150 includes AI training service 152, which can be used to perform various operations associated with training or fitting AI models, such as regression, gradient calculations, backpropagation, loss calculations, or similar. Server 160 includes AI inference service 162, which can be used to perform various operations associated with AI model inference, such as sampling from a distribution, classification, or similar. Example training and inference logic is further described with reference to FIGS. 8A-8B.

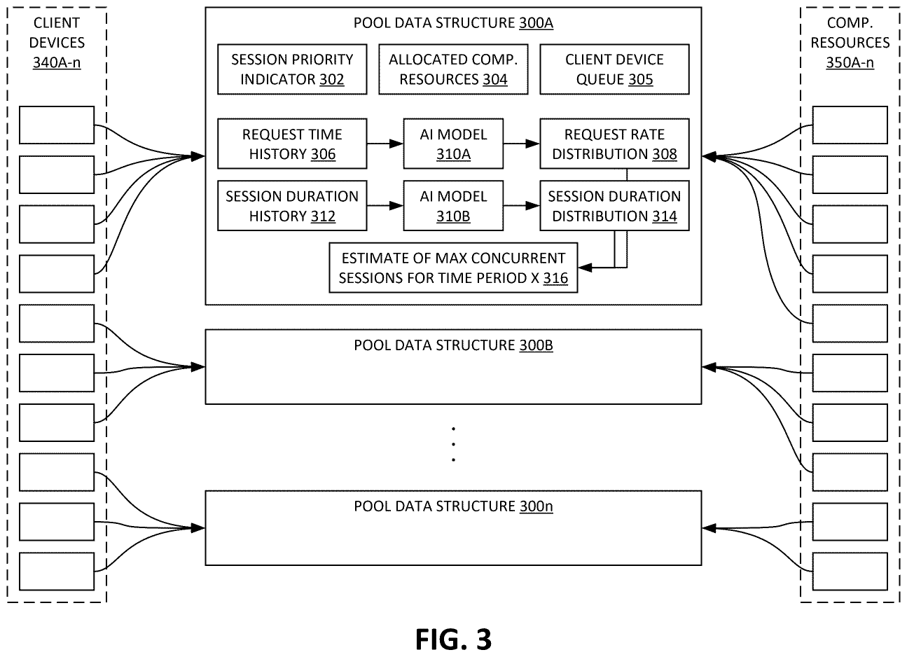

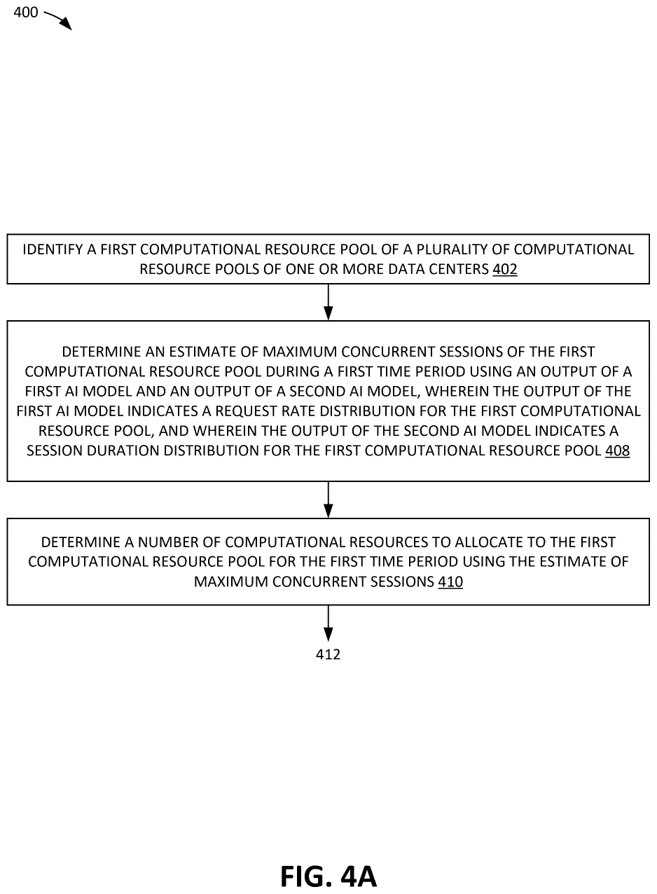

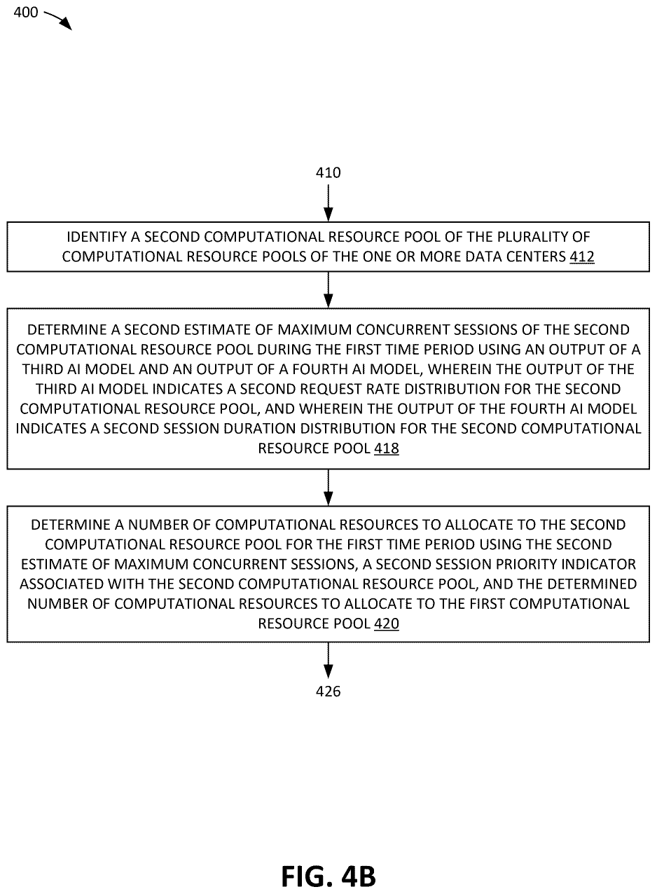

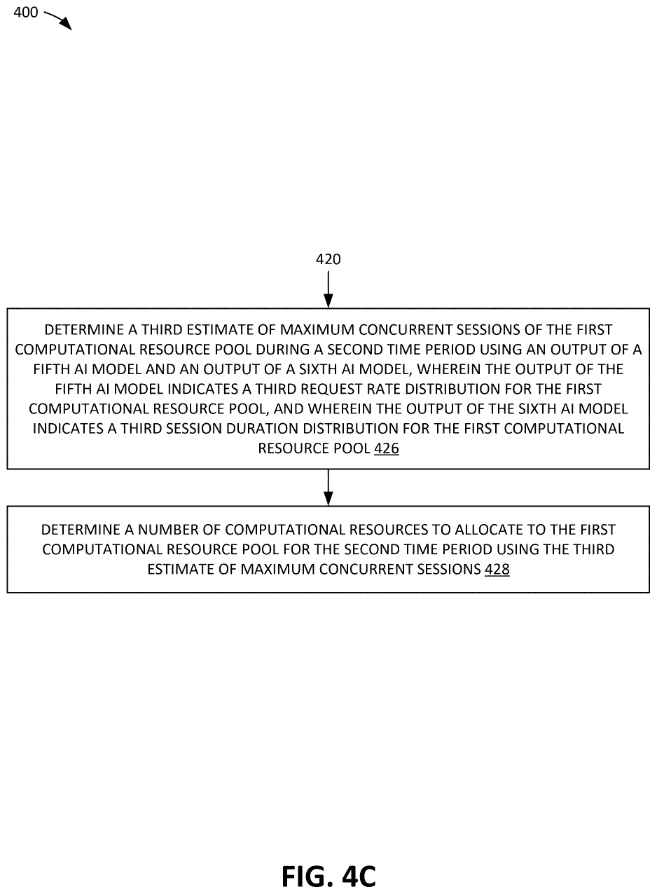

AI training service 152 and/or AI inference service 162 can include one or more AI models 154A-154n. In various embodiments, an AI model of AI models 154A-154n can include statistical models, machine learning (ML) models, deep learning models, discriminative models, generative models, or similar. AI models 154A-154n can use techniques such as linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models. Each of AI models 154A-154n can be trained for different purposes or to fit different training data, as described with reference to FIG. 3 and FIGS. 4A-4B. For example, each of AI models 154A-154n can be trained to model respective historical usage data for computational resource pools of data centers 130A-130n, such as computational resources request time data and session duration data.

Server 170 includes resource pool allocation service 172, which can be used to provision computational resources of data centers 130A-130n into computational resource pools. In an embodiment, resource pool allocation service 172 can use outputs of AI models 154A-154n to determine which or how many computational resources to allocate to a pool. As described with reference to FIG. 6, resource orchestrator 612, job scheduler 628, configuration manager 634, resource manager 636, and/or other components of system 600 can be associated with resource pool allocation service 172.

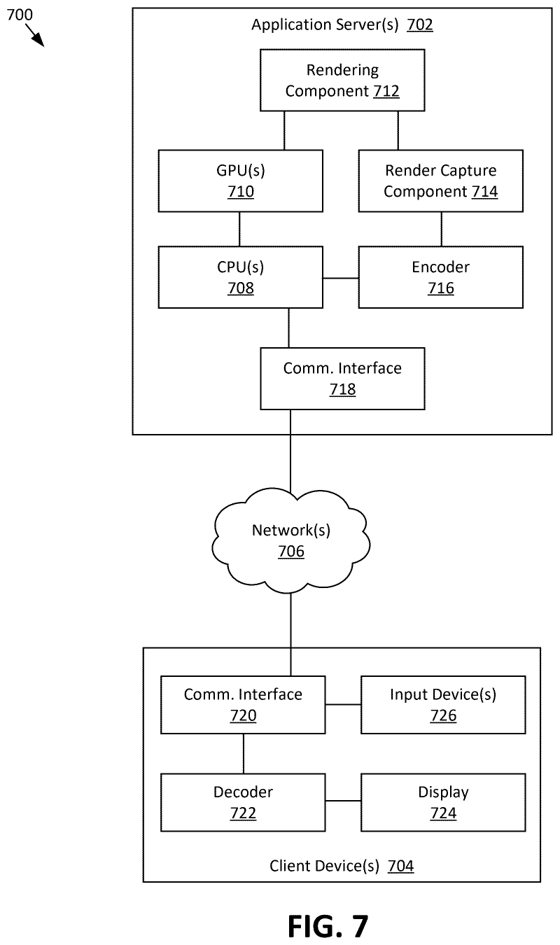

In an embodiment, system 100 can be a game streaming platform, where client devices 120A-120n connect to application servers in data centers 130A-130n over network 110 to stream video games that have been rendered and processed by the respective application server(s). An example content streaming system for a game streaming platform is further described with reference to FIG. 7. In an embodiment, system 100 can be a cloud platform that leases spot instances of computational resources in data centers 130A-130n to users of client devices 120A-120n. In an embodiment, system 100 can include both features. For example, system 100 can prioritize computational resources to the game streaming features and lease the remaining computational resources as spot instances.

FIG. 1B is a block diagram of an example data center 130A, in accordance with an embodiment. Data center 130A includes computational resource pools 132A-132n, each associated with computational resources such as computational resources 134A-134n and 136A-136n. In various embodiments, data center 130A can include more or fewer components in different configurations than those depicted in FIG. 1B. For example, data center 130A can include additional infrastructure described with reference to FIG. 6.

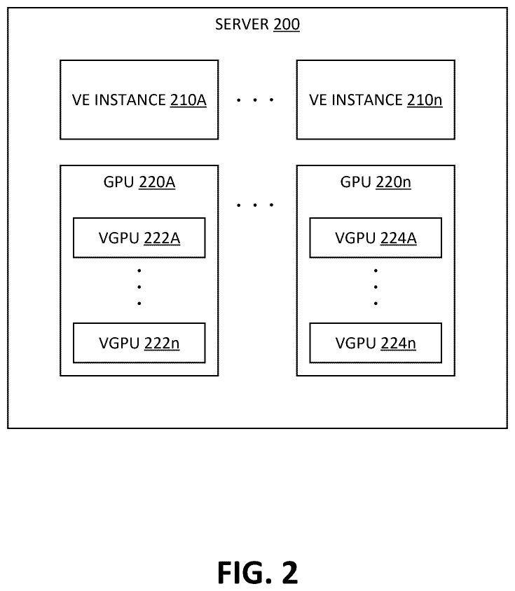

A computational resource pool of computational resource pools 132A-132n can include one or more computational resources, which can correspond to physical (e.g., servers/hosts, GPUs) or virtual (e.g., VMs, vGPUs) resources. Example computational resources are further described with reference to FIG. 2. Computational resources in a computational resource pool can be homogeneous (same computational resource type) or heterogeneous (mixed computational resource types). Similarly, computational resource types can be homogeneous or heterogeneous across pools. Computational resources can be allocated to different pools in different time periods. For example, in a first time period, computational resource 134A is allocated to computational resource pool 132A as depicted in FIG. 1B. In a second time period, computational resource 134A can be reallocated to computational resource pool 132n, e.g., based on changing usage patterns for each pool.

FIG. 2 is a block diagram of example computational resources, in accordance with an embodiment. Server 200 (also referred to as “host” herein) can be a computational resource and can be allocated in its entirety to a computational resource pool, such as computational resource pool 132A of FIG. 1B.

Server 200 can include one or more virtualized environment (VE) instances 210A-210n, which can each correspond to separate computational resources allocated to one or more computational resource pools. VE instances 210A-210n can provide isolated environments for running applications and can correspond to fully virtualized machines running on a hypervisor, application containers sharing OS resources, or other types of virtualization or containerization technologies.

Server 200 can include one or more hardware components, such as GPUs 220A-220n. Hardware components can be used to enable or accelerate various operations and transactions for computational resources. In an embodiment, each hardware component can further be divided into one or more virtualized components, such as vGPUs 222A-222n and 224A-224n. Each hardware component or virtualized component can be associated with a computational resource, such as server 200 or VE instances 210A-210n. Each computational resource can be associated with one or more hardware components or virtualized components.

FIG. 3 is a block diagram of example resource pool data structures 300A-300n corresponding to example resource pools, in accordance with an embodiment. Resource pool data structures 300A-300n can correspond to respective computational resource pools, such as computational resource pools 132A-132n of FIG. 1B. Data structures depicted in FIG. 3 can be stored at and/or used by resource pool allocation service 172 or other component(s) of FIGS. 1A-1B to provide dynamic computational resource pool sizing. Aspects described with reference to example resource pool data structure 300A may or may not apply to example resource pool data structures 300B-300n in various embodiments.

Resource pool data structure 300A includes session priority indicator 302, which can correspond to a priority level for client sessions hosted on computational resources of the respective pool. For example, session priority indicator 302 can correspond to highest, high, medium, and low priorities. Client sessions can correspond to paid sessions/subscribers, free sessions/subscribers, gaming sessions, computation sessions (e.g., scientific data processing), or similar.

Resource pool data structure 300A includes allocated computational resources data structure 304, which can correspond to computational resources that have been allocated to the respective pool. For example, a subset of computational resources 350A-350n (which can correspond to computational resources described with reference to FIGS. 1B-2) can be allocated to the respective pool and stored/referenced in computational resources data structure 304. Allocated computational resources can be used by client devices associated with the respective pool, such as a subset of client devices 340A-340n, which can correspond to client devices 120A-120n of FIG. 1A.

Resource pool data structure 300A includes client device queue 305, which can correspond to client devices (e.g., at least a subset of client devices 340A-340n) waiting to use computational resources of computational resources data structure 304. Client devices can be queued on a first-in first-out basis based on the order in time in which the client devices request computational resources (e.g., request times).

Resource pool data structure 300A includes request time history data 306, which stores a history of times at which client devices request to use computational resources of the respective pool. Resource pool data structure 300A further includes AI model 310A (or reference thereto), which can correspond to one of AI models 154A-154n of FIG. 1A. AI model 310A can use request time history data 306 to model a distribution of request rates for computational resources of the respective pool, which can correspond to request rate distribution 308. In an embodiment, the request rate distribution can be modeled as a Poisson distribution using various AI and ML techniques such as those described herein.

Resource pool data structure 300A includes session duration history data 312, which stores a history of session durations for client devices using computational resources of the respective pool. A session can correspond to a gaming session, a neural network training session, a graphics rendering session, or similar. Resource pool data structure 300A further includes AI model 310B (or reference thereto), which can correspond to one of AI models 154A-154n of FIG. 1A. AI model 310B can use session duration history data 312 to model a distribution of session durations for computational resources of the respective pool, which can correspond to session duration distribution 314. In an embodiment, the session duration can be modeled as a Weibull distribution using various AI and ML techniques such as those described herein.

Resource pool data structure 300A can include on or more estimates of maximum concurrent computational resource sessions for various time periods, such as estimate 316 for time period X. Estimate 316 can be determined using request rate distribution 308 and session duration distribution 314. For example, distributions 308 and 314 can be sampled to simulate the start times and durations of sessions in time period X, and the maximum concurrent sessions can be determined by identifying the highest number of overlapping simulated sessions during time period X. In an embodiment, this simulation process can be repeated multiple times to determine a worst-case maximum concurrent session estimate for time period X. Techniques for generating estimate 316 are further described with reference to FIGS. 4A-4C.

FIGS. 4A-4C are a flow diagram of an example method 400 for providing dynamic computational resource pool sizing for cloud platforms, in accordance with an embodiment. Method 400 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 400. Method 400 can also be associated with a set of instructions stored on a non-transitory computer-readable medium (e.g., magnetic or optical disk, etc.). The instructions, when executed by a processing device, can cause the processing device to perform operations comprising the blocks of method 400. In an embodiment, method 400 is performed by one or more of servers 150-170, client devices 120A-120n, or data centers 130A-130n of FIG. 1A, or components thereof. In an embodiment, method 400 is performed by computing system 500 of FIG. 5. In some embodiments, blocks depicted in FIGS. 4A-4C could be performed simultaneously or in a different order than depicted. Various embodiments can include additional blocks not depicted in FIGS. 4A-4C or a subset of blocks depicted in FIGS. 4A-4C.

At block 402, processing logic identifies a first computational resource pool of a plurality of computational resource pools of one or more data centers. The first computational resource pool can correspond to computational resource pool 132A of FIG. 1B and/or an associated data structure such as resource pool data structure 300A of FIG. 3. The plurality of computational resource pools can correspond to computational resource pools 132A-132n of FIG. 1B, and the one or more data centers can correspond to data centers 130A-130n. The processing logic can identify the first computational resource pool based on a periodic interval (e.g., regular computational resource allocation updates), a non-periodic event (e.g., a manual update triggered by a site reliability engineer), or similar.

At block 408, the processing logic determines an estimate of maximum concurrent sessions of the first computational resource pool during a first time period using an output of a first AI model and an output of a second AI model, wherein the output of the first AI model indicates a request rate distribution for the first computational resource pool, and wherein the output of the second AI model indicates a session duration distribution for the first computational resource pool. The first AI model can correspond to AI model 310A of FIG. 3. The second AI model can correspond to AI model 310B of FIG. 3. The request rate distribution can correspond to request rate distribution 308 and can be, for example, a Poisson distribution. The session duration distribution can correspond to session duration distribution 314 and can be, for example, a Weibull distribution. The estimate of maximum concurrent sessions can correspond to estimate 316 of FIG. 3.

In an embodiment, the processing logic (or other processing logic, e.g., another server) trains/updates the first AI model using historical usage data comprising computational resource allocation request times of the first computational resource pool to determine the request rate distribution for the first computational resource pool. The resource allocation request times can correspond to request time history data 306. As previously described, training the first AI model can include fitting a model to the distribution of the historical request times using regression techniques, neural network techniques, or other types of AI/ML techniques.

In an embodiment, the processing logic (or other processing logic) trains/updates the second AI model using historical usage data comprising session durations for allocated computational resources of the first computational resource pool to determine the session duration distribution for the first computational resource pool. The session durations can correspond to session duration history data 312. As previously described, training the second AI model can include fitting a model to the distribution of the historical session durations using regression techniques, neural network techniques, or other types of AI/ML techniques.

In an embodiment, the first and/or second AI models can be trained/updated to model request rate and session duration distributions for a specific time period (e.g., a first time period) such as an upcoming week, day, hour, or other time period. The historical usage data can correspond to a plurality of second time periods each occurring a respective multiple of a time interval prior to the first time period. For example, the first time period can be a 1-hour period on an upcoming Saturday from 4 pm to 5 pm. The second time periods can be the same 1-hour period on one or more previous Saturdays from 4 pm to 5 pm. As described below, additional models can be trained/updated to model the next 1-hour time period on the upcoming Saturday from 5 pm to 6 pm, and in this case the second time periods can correspond to previous Saturdays from 5 pm to 6 pm.

In an embodiment, determining the estimate of maximum concurrent sessions of the first computational resource pool during the first time period comprises generating a plurality of concurrent session estimates using the first AI model and the second AI model, and identifying a maximum (e.g., worst-case) concurrent session estimate of the plurality of concurrent session estimates. Generating a concurrent session estimate of the plurality of concurrent session estimates can comprise sampling a plurality of simulated request times for the first time period using the first AI model, sampling a plurality of respective simulated session durations for the first time period using the second AI model, and identifying a maximum number of concurrent simulated sessions using the simulated request times and the respective simulated session durations. From the plurality of generated concurrent session estimates, the worst-case concurrent session estimate can be determined by identifying the highest maximum concurrent session estimate.

At block 410, the processing logic determines a number of computational resources to dynamically allocate to the first computational resource pool for the first time period using the estimate of maximum concurrent sessions. For example, the processing logic can use the estimate of maximum concurrent sessions to determine the number of computational resources to allocate to the first computational resource pool to minimize queuing of users/client devices.

In an embodiment, the first computational resource pool is associated with a first session priority indicator (e.g., session priority indicator 302), and determining the number of computational resources to allocate to the first computational resource pool for the first time period further comprises using the first session priority indicator to determine the number of computational resources to allocate to the first computational resource pool for the first time period. The first session priority indicator indicates a priority of the first computational resource pool with respect to priorities of other computational resource pools (e.g., higher or lower) of the plurality of computational resource pools of the one or more data centers.

At block 412, processing logic identifies a second computational resource pool of the plurality of computational resource pools of the one or more data centers. Aspects described with reference to block 402 can similarly apply to block 412. In an embodiment, the first computational resource pool is a cloud gaming resource pool, and the second computational resource pool is a cloud computing resource pool (e.g., for machine learning, graphics processing, etc.).

At block 418, the processing logic determines a second estimate of maximum concurrent sessions of the second computational resource pool during the first time period using an output of a third AI model and an output of a fourth AI model, wherein the output of the third AI model indicates a second request rate distribution for the second computational resource pool, and wherein the output of the fourth AI model indicates a second session duration distribution for the second computational resource pool. Aspects described with reference to block 408 can similarly apply to block 418.

In an embodiment, the processing logic (or other processing logic) trains the third AI model using second historical usage data comprising second computational resource allocation request times of the second computational resource pool to determine the second request rate distribution for the second computational resource pool. Aspects described with reference to the first AI model of block 408 can similarly apply to the third AI model of block 418.

In an embodiment, the processing logic (or other processing logic) trains the fourth AI model using second historical usage data comprising second session durations for allocated computational resources of the second computational resource pool to determine the second session duration distribution for the second computational resource pool. Aspects described with reference to the second AI model of block 408 can similarly apply to the fourth AI model of block 418.

At block 420, the processing logic determines a number of computational resources to dynamically allocate to the second computational resource pool for the first time period using the second estimate of maximum concurrent sessions, a second session priority indicator associated with the second computational resource pool, and the determined number of computational resources to allocate to the first computational resource pool. Aspects described with reference to block 410 can similarly apply to block 420. In addition, the determined number of computational resources to allocate to the first computational resource pool can impact the remaining number of computational resources available (e.g., of computational resources 350A-350n), which can in turn affect the number of computational resources available to allocate to the second computational resource pool.

At block 426, the processing logic determines a third estimate of maximum concurrent sessions of the first computational resource pool during a second time period (e.g., the subsequent upcoming time period) using an output of a fifth AI model and an output of a sixth AI model, wherein the output of the fifth AI model indicates a third request rate distribution for the first computational resource pool, and wherein the output of the sixth AI model indicates a third session duration distribution for the first computational resource pool. Aspects described with reference to block 408 can similarly apply to block 426.

In an embodiment, the processing logic (or other processing logic) trains the fifth AI model using third historical usage data comprising third computational resource allocation request times of the first computational resource pool to determine the third request rate distribution for the first computational resource pool. Aspects described with reference to the first AI model of block 408 can similarly apply to the fifth AI model of block 426.

In an embodiment, the processing logic (or other processing logic) trains the sixth AI model using third historical usage data comprising third session durations for allocated computational resources of the first computational resource pool to determine the third session duration distribution for the first computational resource pool. Aspects described with reference to the second AI model of block 408 can similarly apply to the sixth AI model of block 426.

As described with reference to block 408, the first and second AI models can correspond to a first upcoming time period (e.g., Saturday from 4 pm to 5 pm), and the fifth and sixth AI models can correspond to a subsequent upcoming time period (e.g., Saturday from 5 pm to 6 pm).

At block 428, the processing logic determines a number of computational resources to dynamically allocate to the first computational resource pool for the second time period using the third estimate of maximum concurrent sessions. Aspects described with reference to block 410 can similarly apply to block 428.

FIG. 5 is a block diagram of an example computing device(s) 500 suitable for use in implementing some embodiments of the present disclosure. For example, computing device 500 can correspond to one or more of client devices 120A-120n and/or servers 150-170 of FIG. 1A. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

FIG. 6 illustrates an example data center 600 that may be used in at least one embodiments of the present disclosure. For example, data center 600 can correspond to one or more of data centers 130A-130n of FIG. 1A. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

FIG. 7 is an example system diagram for a content streaming system 700, in accordance with some embodiments of the present disclosure. For example, system 100 can be a content streaming system (e.g., a game streaming system) with multiple computational resource pools of varying priority. FIG. 7 includes application server(s) 702 (which may include similar components, features, and/or functionality to the example computing device 500 of FIG. 5), client device(s) 704 (which may include similar components, features, and/or functionality to the example computing device 500 of FIG. 5), and network(s) 706 (which may be similar to the network(s) described herein). In some embodiments of the present disclosure, the system 700 may be implemented. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 700, for an application session, the client device(s) 704 may only receive input data in response to inputs to the input device(s), transmit the input data to the application server(s) 702, receive encoded display data from the application server(s) 702, and display the display data on the display 724. As such, the more computationally intense computing and processing is offloaded to the application server(s) 702 (e.g., rendering—in particular ray or path tracing—for graphical output of the application session is executed by the GPU(s) of the game server(s) 702). In other words, the application session is streamed to the client device(s) 704 from the application server(s) 702, thereby reducing the requirements of the client device(s) 704 for graphics processing and rendering.

For example, with respect to an instantiation of an application session, a client device 704 may be displaying a frame of the application session on the display 724 based on receiving the display data from the application server(s) 702. The client device 704 may receive an input to one of the input device(s) and generate input data in response. The client device 704 may transmit the input data to the application server(s) 702 via the communication interface 720 and over the network(s) 706 (e.g., the Internet), and the application server(s) 702 may receive the input data via the communication interface 718. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 712 may render the application session (e.g., representative of the result of the input data) and the render capture component 714 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 702. In some embodiments, one or more virtual machines (VMs)—e.g., including one or more virtual components, such as vGPUs, vCPUs, etc.—may be used by the application server(s) 702 to support the application sessions. The encoder 716 may then encode the display data to generate encoded display data and the encoded display data may be transmitted to the client device 704 over the network(s) 706 via the communication interface 718. The client device 704 may receive the encoded display data via the communication interface 720 and the decoder 722 may decode the encoded display data to generate the display data. The client device 704 may then display the display data via the display 724.

FIG. 8A illustrates inference and/or training logic 815 used to perform inferencing and/or training operations associated with one or more embodiments. For example, inference and/or training logic can be used to train and/or perform inference on AI models 154A-154n of FIG. 1A. Details regarding inference and/or training logic 815 are provided below in conjunction with FIGS. 8A and/or 8B.

In at least one embodiment, inference and/or training logic 815 may include, without limitation, code and/or data storage 801 to store forward and/or output weight and/or input/output data, and/or other parameters to configure neurons or layers of a neural network trained and/or used for inferencing in aspects of one or more embodiments. In at least one embodiment, training logic 815 may include, or be coupled to code and/or data storage 801 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 801 may be included with other on-chip or off-chip data storage, including a processor's L1, L2, or L3 cache or system memory.

In at least one embodiment, any portion of code and/or data storage 801 may be internal or external to one or more processors or other hardware logic devices or circuits. In at least one embodiment, code and/or code and/or data storage 801 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 801 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 815 may include, without limitation, a code and/or data storage 805 to store backward and/or output weight and/or input/output data corresponding to neurons or layers of a neural network trained and/or used for inferencing in aspects of one or more embodiments. In at least one embodiment, code and/or data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 815 may include, or be coupled to code and/or data storage 805 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 805 may be included with other on-chip or off-chip data storage, including a processor's L1, L2, or L3 cache or system memory. In at least one embodiment, any portion of code and/or data storage 805 may be internal or external to on one or more processors or other hardware logic devices or circuits. In at least one embodiment, code and/or data storage 805 may be cache memory, DRAM, SRAM, non-volatile memory (e.g., Flash memory), or other storage. In at least one embodiment, choice of whether code and/or data storage 805 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 801 and code and/or data storage 805 may be separate storage structures. In at least one embodiment, code and/or data storage 801 and code and/or data storage 805 may be same storage structure. In at least one embodiment, code and/or data storage 801 and code and/or data storage 805 may be partially same storage structure and partially separate storage structures. In at least one embodiment, any portion of code and/or data storage 801 and code and/or data storage 805 may be included with other on-chip or off-chip data storage, including a processor's L1, L2, or L3 cache or system memory.

In at least one embodiment, inference and/or training logic 815 may include, without limitation, one or more arithmetic logic unit(s) (“ALU(s)”) 810, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 820 that are functions of input/output and/or weight parameter data stored in code and/or data storage 801 and/or code and/or data storage 805. In at least one embodiment, activations stored in activation storage 820 are generated according to linear algebraic and or matrix-based mathematics performed by ALU(s) 810 in response to performing instructions or other code, wherein weight values stored in code and/or data storage 805 and/or code and/or data storage 801 are used as operands along with other values, such as bias values, gradient information, momentum values, or other parameters or hyperparameters, any or all of which may be stored in code and/or data storage 805 or code and/or data storage 801 or another storage on or off-chip.

In at least one embodiment, ALU(s) 810 are included within one or more processors or other hardware logic devices or circuits, whereas in another embodiment, ALU(s) 810 may be external to a processor or other hardware logic device or circuit that uses them (e.g., a co-processor). In at least one embodiment, ALUs 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 801, code and/or data storage 805, and activation storage 820 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 820 may be cache memory, DRAM, SRAM, non-volatile memory (e.g., Flash memory), or other storage. In at least one embodiment, activation storage 820 may be completely or partially within or external to one or more processors or other logical circuits. In at least one embodiment, choice of whether activation storage 820 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 815 illustrated in FIG. 8A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8A may be used in conjunction with central processing unit (“CPU”) hardware, graphics processing unit (“GPU”) hardware or other hardware, such as data processing unit (“DPU”) hardware, or field programmable gate arrays (“FPGAs”).

FIG. 8B illustrates inference and/or training logic 815, according to at least one or more embodiments. In at least one embodiment, inference and/or training logic 815 may include, without limitation, hardware logic in which computational resources are dedicated or otherwise exclusively used in conjunction with weight values or other information corresponding to one or more layers of neurons within a neural network. In at least one embodiment, inference and/or training logic 815 illustrated in FIG. 8B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8B may be used in conjunction with central processing unit (CPU) hardware, graphics processing unit (GPU) hardware or other hardware, such as data processing unit (“DPU”) hardware, or field programmable gate arrays (FPGAs). In at least one embodiment, inference and/or training logic 815 includes, without limitation, code and/or data storage 801 and code and/or data storage 805, which may be used to store code (e.g., graph code), weight values and/or other information, including bias values, gradient information, momentum values, and/or other parameter or hyperparameter information. In at least one embodiment illustrated in FIG. 8B, each of code and/or data storage 801 and code and/or data storage 805 is associated with a dedicated computational resource, such as computational hardware 802 and computational hardware 806, respectively. In at least one embodiment, each of computational hardware 802 and computational hardware 806 comprises one or more ALUs that perform mathematical functions, such as linear algebraic functions, only on information stored in code and/or data storage 801 and code and/or data storage 805, respectively, result of which is stored in activation storage 820.

In at least one embodiment, each of code and/or data storage 801 and 805 and corresponding computational hardware 802 and 806, respectively, correspond to different layers of a neural network, such that resulting activation from one “storage/computational pair 801/802” of code and/or data storage 801 and computational hardware 802 is provided as an input to “storage/computational pair 805/806” of code and/or data storage 805 and computational hardware 806, in order to mirror conceptual organization of a neural network. In at least one embodiment, each of storage/computational pairs 801/802 and 805/806 may correspond to more than one neural network layer. In at least one embodiment, additional storage/computation pairs (not shown) subsequent to or in parallel with storage computation pairs 801/802 and 805/806 may be included in inference and/or training logic 815.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some implementations, process of obtaining, acquiring, receiving, or inputting analog or digital data may be accomplished by transferring data via a serial or parallel interface. In another implementation, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
identifying a first computational resource pool of a plurality of computational resource pools of one or more data centers;
determining an estimate of maximum concurrent sessions of the first computational resource pool during a first time period based at least on a request rate distribution for the first computational resource pool generated using a first artificial intelligence (AI) model and a session duration distribution for the first computational resource pool generated using a second AI model; and
determining a number of computational resources to dynamically allocate to the first computational resource pool for the first time period based on the estimate of maximum concurrent sessions.

2. The method of claim 1, further comprising:
updating the first AI model using historical usage data comprising computational resource allocation request times of the first computational resource pool to determine the request rate distribution for the first computational resource pool.

3. The method of claim 1, further comprising:
updating the second AI model using historical usage data comprising session durations for allocated computational resources of the first computational resource pool to determine the session duration distribution for the first computational resource pool.

4. The method of claim 3, wherein the historical usage data corresponds to a plurality of second time periods each occurring a respective multiple of a time interval prior to the first time period.

5. The method of claim 1, wherein the first AI model corresponds to a Poisson distribution, and wherein the second AI model corresponds to a Weibull distribution.

6. The method of claim 1, wherein determining the estimate of maximum concurrent sessions of the first computational resource pool during the first time period comprises:
generating a plurality of concurrent session estimates using the first AI model and the second AI model; and
identifying a maximum concurrent session estimate of the plurality of concurrent session estimates.

7. The method of claim 6, wherein generating a concurrent session estimate of the plurality of concurrent session estimates comprises:
sampling a plurality of simulated request times using the first AI model;
sampling a plurality of respective simulated session durations using the second AI model; and
identifying a maximum number of concurrent simulated sessions using the simulated request times and the respective simulated session durations.

8. The method of claim 1, wherein the first computational resource pool is associated with a first session priority indicator, and wherein determining the number of computational resources to allocate to the first computational resource pool for the first time period further comprises:
using the first session priority indicator to determine the number of computational resources to allocate to the first computational resource pool for the first time period, wherein the first session priority indicator indicates a priority of the first computational resource pool with respect to priorities of other computational resource pools of the plurality of computational resource pools of the one or more data centers.

9. The method of claim 8, further comprising:
identifying a second computational resource pool of the plurality of computational resource pools of the one or more data centers;
determining a second estimate of maximum concurrent sessions of the second computational resource pool during the first time period based on a second request rate distribution for the second computational resource pool generated using a third AI model and a second session duration distribution for the second computational resource pool generated by a fourth AI model; and
determining a number of computational resources to allocate to the second computational resource pool for the first time period using the second estimate of maximum concurrent sessions, a second session priority indicator associated with the second computational resource pool, and the determined number of computational resources to allocate to the first computational resource pool.

10. The method of claim 9, wherein the first computational resource pool is a cloud gaming resource pool, and wherein the second computational resource pool is a cloud computing resource pool.

11. A system comprising:
one or more processors to perform operations comprising:
identifying a first computational resource pool of a plurality of computational resource pools;
determining an estimate of maximum concurrent sessions of the first computational resource pool during a first time period based at least on a request rate distribution for the first computational resource pool and a session duration distribution for the first computational resource pool generated by at least one artificial intelligence (AI) model; and
dynamically allocating a number of computational resources to the first computational resource pool for the first time period based on the estimate of maximum concurrent sessions.

12. The system of claim 11, the operations further comprising:
updating the at least one AI model using historical usage data comprising computational resource allocation request times of the first computational resource pool to determine the request rate distribution for the first computational resource pool.

13. The system of claim 11, the operations further comprising:
updating the at least one AI model using historical usage data comprising session durations for allocated computational resources of the first computational resource pool to determine the session duration distribution for the first computational resource pool.

14. The system of claim 13, wherein the historical usage data corresponds to a plurality of second time periods each occurring a respective multiple of a time interval prior to the first time period.

15. The system of claim 11, wherein the request rate distribution corresponds to a Poisson distribution, and wherein the session duration distribution corresponds to a Weibull distribution.

16. The system of claim 11, wherein determining the estimate of maximum concurrent sessions of the first computational resource pool during the first time period comprises:
generating a plurality of concurrent session estimates using the at least one AI model; and
identifying a maximum concurrent session estimate of the plurality of concurrent session estimates.

17. The system of claim 16, wherein generating a concurrent session estimate of the plurality of concurrent session estimates comprises:
sampling a plurality of simulated request times using the at least one AI model;
sampling a plurality of respective simulated session durations using the at least one AI model; and
identifying a maximum number of concurrent simulated sessions using the simulated request times and the respective simulated session durations.

18. The system of claim 11, wherein the first computational resource pool is associated with a first session priority indicator, and wherein determining the number of computational resources to allocate to the first computational resource pool for the first time period further comprises:
using the first session priority indicator to determine the number of computational resources to allocate to the first computational resource pool for the first time period, wherein the first session priority indicator indicates a priority of the first computational resource pool with respect to priorities of other computational resource pools of the plurality of computational resource pools.

19. The system of claim 18, the operations further comprising:
identifying a second computational resource pool of the plurality of computational resource pools;
determining a second estimate of maximum concurrent sessions of the second computational resource pool during the first time period based on a second request rate distribution for the second computational resource pool and a second session duration distribution for the second computational resource pool generated by the at least one AI model; and
determining a number of computational resources to allocate to the second computational resource pool for the first time period using the second estimate of maximum concurrent sessions, a second session priority indicator associated with the second computational resource pool, and the determined number of computational resources to allocate to the first computational resource pool.

20. At least one processor comprising:
processing circuitry to dynamically allocate, for a computational resource pool of a plurality of computational resource pools, a number of computational resources determined based on an estimate of maximum concurrent sessions of the computational resource pool during a time period, the estimate of maximum concurrent sessions based on a request rate distribution and a session duration distribution generated by at least one artificial intelligence (AI) model.
